(19) United States
(12) Patent Application Publication
(10) Pub. No.: US 2007/0022557 A1
(43) Pub. Date: Feb. 1, 2007

(54) Wiper arm for a windshield wiper device

(75) Inventor: Christian Wilms, Koersel-Beringen (BE)

Correspondence Address: MICHAEL BEST & FRIEDRICH, LLP, 100 E WISCONSIN AVENUE, MILWAUKEE, WI, 53202, US

(73) Assignee: ROBERT BOSCH GMBH, Stuttgart (DE)

(21) Appl. No.: 11/496,301

(22) Filed: Jul. 31, 2006

(30) Foreign Application Priority Data
Aug. 1, 2005 (DE) 10 2005 036 044.0
Sep. 5, 2005 (DE) 10 2005 041 997.6

(51) Int. Cl. B60S 1/34; B60S 1/32

(52) U.S. Cl. 15/250.351

(57) ABSTRACT

Disclosed is a wiper arm (10) for a windshield wiper device, in particular for a motor vehicle. During operation this wiper arm is able to move in a pendulum fashion in a plane (E) over a windshield and is comprised of at least a first part (12) and a second part (18) fastened to the first part (12), which has a fastening means (22) on its free end for fastening a wiper blade. In accordance with the invention, a shock-absorbing connection (22) is provided between the first part (12) and the second part (18).

### BACKGROUND OF THE INVENTION

The invention relates to a wiper arm for a windshield wiper device in accordance with the species of the independent claim.

Numerous wiper arms for windshield wiper devices of motor vehicles are known, e.g., from DE-A-103 315 69, which during operation are able to move in a pendulum fashion in a plane over a windshield and are comprised of at least an articulated part as a first part on which an extension is fastened as a second part, which extends the articulated part. The extension has on its free end, i.e., the end that is facing away from the articulated part, a fastening means for fastening a wiper blade.

In various operating conditions, rattling can occur with these types of wiper arms so that the wiper arm with the wiper blade moves over the windshield in a jerky manner. This phenomenon is also known as the slip-stick effect.

In order to avoid this effect, an electronic method that counteracts this slip-stick effect was proposed in DE-A-199 53 515. However, these types of electronic methods are complex and costly.

### SUMMARY OF THE INVENTION

The advantage of the wiper arm in accordance with the invention is that a shock-absorbing connection is provided between the first part and the second part. Because of this type of connection, the rattling, during which strongly varying stress is predominant, can be effectively prevented so that an optimal wiped image is always achieved. As a result, the invention provides a simple and cost-effective possibility of preventing the slip-stick effect on the windshield.

It is especially advantageous if the connection has a dampening for shock absorption, which absorbs shocks in the plane of the window in which the wiper arm moves.

A connection, which partially surrounds the second part, in particular in the area of the first part, and is surrounded by the first part, has proven to be particularly simple and effective. It is cost-effective to manufacture and guarantees a high level of stability.

If the extension and/or the connection has stabilizing means for stabilizing the longitudinal extension, the wiped image is improved further and the stability of the wiper arm is increased.

It is especially simple and cost-effective if the second part is embodied as a rod and the connection is comprised of a plastic jacket, which is slipped onto one end of the rod.

Particularly good dampening behavior can be achieved in that the first part surrounds the second part in a clamp-like manner so that an open area is created and the connection projects into the open area. This is also particularly simple and cost-effective to fabricate.

It is just as cost-effective if the connection is embodied partially of plastic since this can be processed easily using an injection molding process. This applies especially if the connection is embodied as an elastic plastic mat or if the connection is embodied as an elastic, tubular plastic part.

### BRIEF DESCRIPTION OF THE DRAWINGS

One exemplary embodiment of the invention is depicted in the drawings and explained in greater detail in the following description. The drawings show:

FIG. 1 A perspective representation of a wiper arm in accordance with the invention.

FIG. 2 A detail of the connection of the wiper arm in accordance with the invention.

FIG. 3 A detail of the articulated part, extension and connection of a wiper arm in accordance with the invention.

FIG. 4 An extension of a wiper arm in accordance with the invention before assembly.

### DETAILED DESCRIPTION

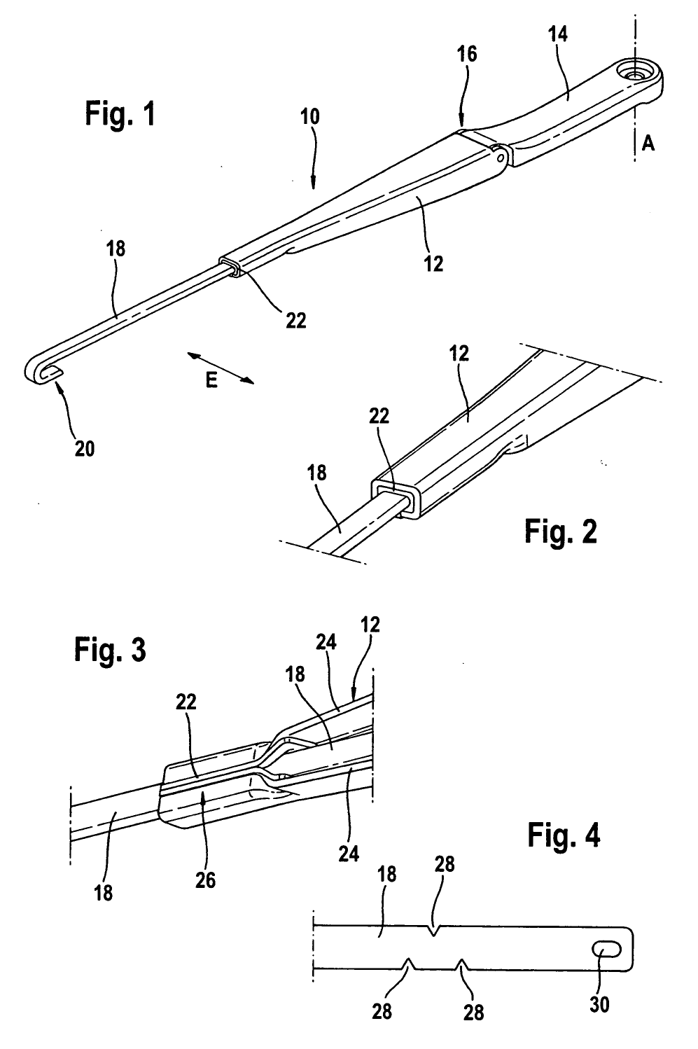

FIG. 1 shows a perspective representation of a wiper arm 10 in accordance with the invention. During operation, the wiper arm 10 moves in a pendulum fashion around an axis A so that a plane E is wiped by the pendulum motion. This plane E is typically essentially parallel to the windshield of the motor vehicle.

The wiper arm 10 is comprised essentially of a fastening part 14 to which an articulated part 12 is coupled as a first part. The fastening part 14 is used to fasten the wiper arm 10 to a wiper shaft of the windshield wiper device. The articulated part 12 is connected to the fastening part 14 by a hinge 16. In addition, the articulated part 12 is extended on its free end that faces away from the fastening part 14 by an extension 18 as a second part, which is embodied as a rod. A fastening means 20, which is used to fasten a wiper blade that is not shown here for the sake of providing an unimpaired view, is arranged on the free end of the extension 18. The fastening means 20 is therefore arranged on the end of the extension 18, which is facing away from the articulated part 12. The articulated part 12 and the fastening part 14 are each embodied in this case as bent sheet metal parts. In a variation of the invention, the fastening part 14 can also be embodied as a cast part and/or as a plastic part.

A shock-absorbing connection 22, which is comprised of an elastic plastic, is provided between the extension 18 that is embodied as a rod and the articulated part 12. The articulated part 12 and the fastening part 14 are embodied in this case as sheet metal parts, which are bent box-like into a reverse U-shaped profile in cross section. On its end facing the fastening part 14, the articulated part 12 is somewhat wider than the fastening part 14 so that it surrounds it laterally. The articulated part 14 is tapered on its free end that faces away from the fastening part 12 and encircles the rod 18 as well as the connection 22.

FIG. 2 shows a detail of the area of the connection 22 of the wiper arm 10 in accordance with the invention. The extension 18 is surrounded by the connection 22 on its end that faces away from the fastening means 20. The free end of the articulated part 12 fits snuggly around the connection 22 and almost completely surrounds the connection 22.

FIG. 3 also shows a perspective representation of the section from FIG. 2, but from below, i.e., as seen from the windshield of the motor vehicle. The articulated part 12 has a reverse U-shaped form in cross section so that a base with two side cheeks 24 is formed. The side cheeks are bent to the inside in the area facing the extension 18 of the free end of the articulated part 12 so that the side cheeks 24 of the articulated part 12 grip around the connection 22 and the extension 18. In the process, an open area 26 is formed between the two bent side cheeks 24, through which a portion of the connection 22 projects. Ideally, the connection 22 terminates flush with the outer side of the side cheeks 24 that are bent to the inside. In this way, the articulated part 12 has no direct contact with the extension 18 since the connection 22 is arranged between the articulated part 12 and the extension 18 so that vibrations and shocks are dampened. In a variation, the side cheeks 24 can also be dimensioned in such a way that they impact each other directly so that no open area 26 is created. In just the same way, the side cheeks 24 can have an overmeasure and overlap as a result and/or cooperate via matching structures in a clamp-like, positively-engaged, integral or adherent manner.

FIG. 4 shows the end of the extension 18, which faces away from the fastening means 20. The extension 18 is comprised of a rod that is approximately between 0.5 and 1.5 cm wide and between 0.5 and 5 mm thick. In the area in which the connection 22 is arranged, the rod 18 has several, in particular two to four, preferably three notches, which serve as stabilizing means 28. If the connection 22 is placed around the notches 28 when the wiper arm 10 is manufactured, then the connection 22 is pressed into the notches 28 when the side cheeks 24 are clamped or bent around, which can also involve lateral pressing. This approach guarantees that the extension 18 is secured against displacement in the longitudinal direction. In a variation, additional securing means can naturally also be embodied directly on the connection 22 and these can also cooperate with the notches 28 of the extension 18 for example. In just the same way, it is possible to provide corresponding securing means 28 on the articulated part 12 and/or on the side cheeks 24 of the articulated part 12 and these securing means can also cooperate with securing means 28 of the extension 18 and/or the connection 22. For example, nubs, notches or circumferential projections can be provided here, which produce stabilization in the longitudinal direction of the extension 18.

An opening 30 is provided on the end of the extension 18 that faces the articulated part 12, i.e., in an assembled position it is situated in the inner area of the reverse U-shaped articulated part 12. A tensioning means, for example a tension spring, can be hooked into this opening.

In a variation of the invention, the connection 22 and the extension 18 can also be embodied as a one-part piece so that a shock-absorbing extension is produced such that shocks occurring in plane E are reliably dampened and therefore absorbed without impairing the stability in the longitudinal direction.

The connection 22 is comprised of an elastic plastic mat, which is inserted into the articulated part when the wiper arm 10 is assembled. Then the extension 18 is inserted and the side cheeks 24 are pressed to the inside of the U-shaped profile. In a variation, it is naturally also possible to embody the connection as an elastic, tubular plastic part. This can be accomplished in that an essentially rectangular plastic part is slid onto the extension 18 and then the extension 18 with the plastic part as the connection 22 is inserted into the articulated part 12 and the side cheeks 24 of the articulated part 12 are bent around so that the extension 18 is securely clamped with the connection 22. Basically, the connection can also be embodied of another shock-absorbing material, e.g., a suitable ceramic. The force that is applied to the side cheeks 24 to press the connection 22 and the rod 18 is basically calculated in this case so that the extension 18 cannot move in its longitudinal direction and only shock absorption occurs in plane E, i.e., the pendulum plane of the wiper arm 10.

In a variation of the invention, the fastening part 14 can be provided as the first part and the articulated part 12 as the second part. The shock-absorbing connection 22 is then arranged in the area of the hinge 16 or formed by the hinge 16 itself.

In another variation, the fastening part 14 can be executed as two-piece or multi-piece and the shock-absorbing connection 22 can be arranged there.

1. Wiper arm (10) for a windshield wiper device for a motor vehicle, which during operation is able to move in a pendulum fashion in a plane (E) over a windshield, comprised of at least an articulated first part (12) and a second part (18) fastened to the first part (12), the second part being an extension that extends the first part (12) and has a free end with a fastening means (22) for fastening a wiper blade, characterized in that a shock-absorbing connection (22) is provided between the first part (12) and the second part (18).

2. Wiper arm (10) according to claim 1, characterized in that the connection (22) has a dampening for shock absorption, which absorbs shocks in the plane (E).

3. Wiper arm (10) according to claim 1, characterized in that the connection (22) partially surrounds the second part (18) in the area of the first part (12), and is surrounded by the first part (12).

4. Wiper arm (10) according to claim 1, characterized in that at least one of the second part (18) and the connection (22) have stabilizing means (28) for stabilizing the longitudinal extension.

5. Wiper arm (10) according to claim 1, characterized in that the second part (18) is embodied as an extending rod and the connection (22) is comprised of a plastic jacket, which is slipped onto one end of the rod (18).

6. Wiper arm (10) according to claim 1, characterized in that the articulated first part (12) surrounds the second part (18) in a clamp-like manner so that an open area (26) is created and the connection (22) projects into the open area (26).

7. Wiper arm (10) according to claim 1, characterized in that the connection (22) is made at least partially of plastic.

8. Wiper arm (10) according to claim 1, characterized in that the connection (22) includes an elastic plastic mat.

9. Wiper arm (10) according to claim 1, characterized in that the connection (22) includes an elastic, tubular plastic part.

10. Wiper arm (10) according to claim 2, characterized in that the connection (22) partially surrounds the second part (18) in the area of the first part (12), and is surrounded by the first part (12).

11. Wiper arm (10) according to claim 10, characterized in that at least one of the second part (18) and the connection (22) have stabilizing means (28) for stabilizing the longitudinal extension.

12. Wiper arm (10) according to claim 11, characterized in that the second part (18) is embodied as an extending rod and the connection (22) is comprised of a plastic jacket, which is slipped onto one end of the rod (18).

13. Wiper arm (10) according to claim 12, characterized in that the articulated first part (12) surrounds the second part (18) in a clamp-like manner so that an open area (26) is created and the connection (22) projects into the open area (26).

14. Wiper arm (10) according to claim 13, characterized in that the connection (22) is made at least partially of plastic.

15. Wiper arm (10) according to claim 14, characterized in that the connection (22) includes an elastic plastic mat.

16. Wiper arm (10) according to claim 15, characterized in that the connection (22) includes an elastic, tubular plastic part.
